(19) United States
(12) Patent Application Publication
(10) Pub. No.: US 2009/0066476 A1
(43) Pub. Date: Mar. 12, 2009

(54) Method of self-service access control for frequent guests of a housing facility

(75) Inventor: Fazal Syed Raheman, Dubai (AE)

Correspondence Address: Mark J. Pandiscio;Pandiscio & Pandiscio, P.C., 470 Totten Pond Road, Waltham, MA, 02451-1914, US

(73) Assignee: FoneKey, Inc., Farmingdale, NY (US)

(21) Appl. No.: 12/148,046

(22) Filed: Apr. 16, 2008

Related U.S. Application Data
(60) Provisional application No. 60/923,788, filed on Apr. 17, 2007.

(51) Int. Cl. H04B 1/02; H04M 1/00

(52) U.S. Cl. 340/5.64; 455/556.1

(57) ABSTRACT

An improved electronic lock with keyless, card-less digital key system is provided for use in residential and commercial buildings. The invention describes a novel method of self-service remote assignment and access authorization to the facility for a specified period of time, and consequent contact-less operation of door locks by means of a mobile device. The method requires no interaction with the facility's front desk or reception or management for checking in, checking out, payments, or access key pick up or drop off.

### STATEMENT REGARDING FEDERALLY SPONSORED RESEARCH OR DEVELOPMENT

Not Applicable

### REFERENCE TO A MICROFICHE APPENDIX

Not Applicable

### TECHNICAL FIELD

The present invention relates generally to wireless networks in general, and more particularly to a network architecture that enables a wireless communication network hand held device to control the access to a housing facility by means of a wireless telecommunication protocol to communicate with the building's property management system, and uses direct peer to peer radio frequency protocol to operate the electronic lock.

### BACKGROUND OF THE INVENTION

In a pending application bearing No. 11/507,557 filed Aug. 22, 2006 this inventor had described a novel “[m]ultifunction keyless and card-less method and system of securely operating and managing facilities with electronic door locks.” That invention improvised the operation of electronic locks and fully integrated the local network of electronic locks with a wireless device network. Thus that invention bestowed a high level of convenience and control in the hands of the housing residents on one hand, and seamless integration of management and administration of the facility for the facility owner on the other. That invention claimed high customer satisfaction for the residents and significant cost savings for the building management. However, the practical implementation of that invention required that all the electronic locks in the housing facility be connected to a common computer. Such local area network of the locks was then interfaced with the wireless gateway to which the users connected their mobile device for operating the locks. The essential element of that invention was that the locks were online and always accessible by the wireless gateway. This limited the applicability of that invention to online locks that were connected by running the cables through the door. Wireless networking of the locks also required running the power supply to the locks through the door panel, as the lock battery would last only a few days if the wireless mechanism on the lock is always alive. Networking of the locks in such a way may still be a good long term strategy for the new building constructions, but most present buildings do not feature online locks. Such property managers may find networking of the locks too cumbersome especially when the occupancy rate of the property is very high. The other pain point in the previous invention was the latency because of the total reliance on the public cellular networks. Although most reputed mobile networks nowadays report a very high efficiency in terms of call setup rate approaching 100% and average call setup time of less than 3 seconds, the few seconds delay in the user's ability to open the lock leaves some room for further improvisations.

The instant invention provides further improvements on this inventor's above described pending invention. Firstly, it makes the previous invention work with the offline locks. Secondly, it eliminates the network latency by establishing a direct peer to peer wireless connection between the user's wireless device and the electronic lock. Accordingly, there is a need for a system described herein to overcome the limitations of the prior art.

### DESCRIPTION OF THE PRIOR ART

The co-pending application cited in the previous section bearing No. 11/507,557 filed Aug. 22, 2006 describes the prior art in great detail. This invention supplements and further enhances the method described in the '557 application, which was limited to online locks that were network-able.

### BRIEF SUMMARY OF THE INVENTION

An improved electronic lock with keyless, card-less digital key system is provided for use in residential and commercial buildings particularly in hospitality industry. The hospitality industry constantly strives to improve the amenities and facilities extended to their guests. It was hospitality industry that first adopted the electronic locks, which were operated by credit card sized card keys and not the conventional metal keys. The guest room access has since been improvised by the use of chip-based smart cards and by online access to many of the guest services. The management of the facilities and housekeeping has also been computerized to enhance efficiency. However, the full integration of the card key access with the rest of the facility management and administration interface is not possible on account of limitation of the card key to interact with the rest of the network in real time.

One of the pending inventions of this inventor as stated in the previous section describes a novel new method of access control and management of areas or premises secured by electronic locks, using a new keyless and cardless approach to the problem of access code synchronization between the locks, keys and overall facility administration. That invention required the locks in a network and relied on public cellular networks for each and every interaction with the lock. Consequently, it is an advantage of the invention that a plurality of locks in a housing facility can be seamlessly and wirelessly controlled by resident's and would be resident's mobile devices without having to either create a local area network of locks or use the public cellular networks for simply operating the locks.

It is therefore an object of the present invention to provide a user friendly, cost-saving, value adding self-service infrastructure for check-in, check-out and access control that overcomes the problems residing in the prior art. It is another object of the invention to provide a keyless and card-less access that replaces conventional electronic card keys, in which the access code disclosure device is a wireless device such as a mobile phone.

It is yet another object of the present invention to provide a wireless device resident digital key operating a plurality of offline electronic locks that need not be networked to communicate with the mobile device. It is still another object of the invention to provide a secure access code that is transmitted by the mobile device in real time by direct peer to peer connection with the lock. It is also an object of the invention to provide a digital key pick up and drop off terminal/kiosk for encoding the access code on the user's wireless device after the user checks in the facility and erasing the access code after the user checks out.

The foregoing discussion summarizes some of the more pertinent objects of the present invention. These objects should be construed to be merely illustrative of some of the more prominent features and applications of the invention. Applying or modifying the disclosed invention in a different manner can attain many other beneficial results or modifying the invention as will be described. Accordingly, referring to the following drawings may have a complete understanding of the invention. Description of the preferred embodiment is as follows.

### BRIEF DESCRIPTION OF THE SEVERAL VIEWS OF THE DRAWINGS

FIG. 1 is a block diagram illustrating the network architecture of a preferred embodiment implemented through five nodes and seven modules.

FIG. 2 is a block diagram illustrating the guestroom access control architecture in a preferred embodiment as implemented for guest check-out and room key 15 drop off.

### DETAILED DESCRIPTION OF THE INVENTION

The novel features of the instant invention can be deployed in any housing facility in general and multi-unit buildings in particular. However, the preferred embodiment of the invention is described, as it would be implemented in a hotel as a tool for enhancing guest experience as implemented in the hotel's loyalty program. For the purpose of the description it is assumed that the client-server infrastructure, as described in this inventor's co-pending application Ser. No. 11/507,557 filed Aug. 22, 2006, facilitating the online reservation and remote check-in and check-out using guest's mobile device, is already in place. It is also assumed that the guest is already registered with the housing facility's reservation system as an authorized occupier of the facility for a specified period of time. It is therefore also assumed that the guest identifies his or her authorized RF (radiofrequency) tagged mobile device to the reservation system at the time of reservation.

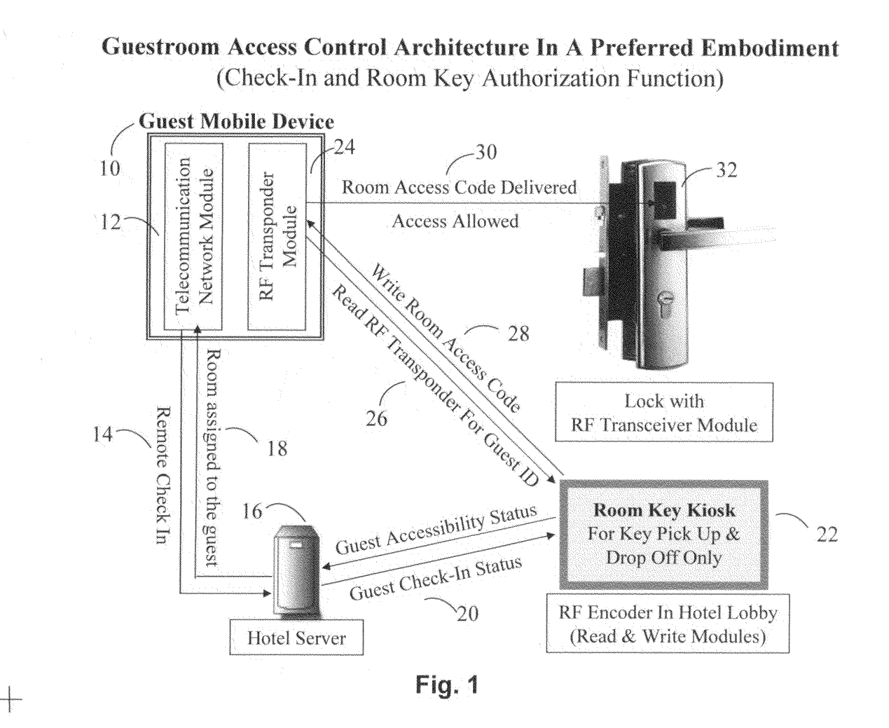

As represented in FIG. 1 the preferred embodiment of the present invention, the implementation begins with the guest having already remotely checked-in from airport or on his way to the hotel using his mobile device 10. Such check-in uses either the text messaging protocol, voice protocol or the GPRS protocols provided by the service provider of the public telecommunication network 12 as described in this inventor's previously cited co-pending application. On guest's initiation the mobile device's telecommunication network module connects 14 to the hotel's remote server 16. After verification of the guest ID and his room reservation status the hotel server assigns a room and sends the room number confirmation 18 to the guest's mobile device. The hotel server also updates 20 the guest's ID and check-in status to the Room Key Kiosk, which is an RF Encoder Terminal 22 located in a visibly conspicuous location in the hotel lobby. The RF Encoder Terminal is connected to the hotel's local area network and interfaced with the hotel's property management software. The RF Encoder is also in sync with the access code ID that operates each of the RF enabled locks within the hotel property. Such RF Encoder is a radiofrequency transceiver with capabilities to read and write any transponder within the same frequency range in its effective vicinity. As the guest enters the hotel lobby he walks to the Room Key Kiosk to upload the digital room key to the RF Transponder Module 24 of his mobile device. Such authorization of the room access code is done by simply bringing the mobile device within the reading and writing range of the RF Encoder Terminal. The read module of the RF Encoder Terminal reads 26 the ID of the guest on the guest's mobile RF Transponder module. The guest ID is authenticated by the RF Encoder 25 by reference to the guest's profile, check-in and room allotment status 20 in the hotel's database. After authentication of the guest's mobile device, the write module of the RF Encoder writes 28 the room access code to the guest's RF Transponder. The guestroom access digital key is thus uploaded to the guest's mobile device. After uploading the room access key to his mobile device the guest walks straight to his room and opens the assigned room by contact less delivery of the room access code 30 to the lock's Transceiver Module 32. From then on the guest mobile device can be used by the guest to operate the guest room lock by just bringing the mobile device within the range of the lock's radio waves transmission field. Such distance of the guest mobile device from the lock depends on the type of radiofrequency generated by the Transceiver Module within the lock, and the Transponder Module within the guest's mobile device. The RF Encoder Terminal thus functions as the self service automatic room access key pick up kiosk from where the guest can directly upload the room access code on his mobile device resident RFID tag without having to wait at the front desk.

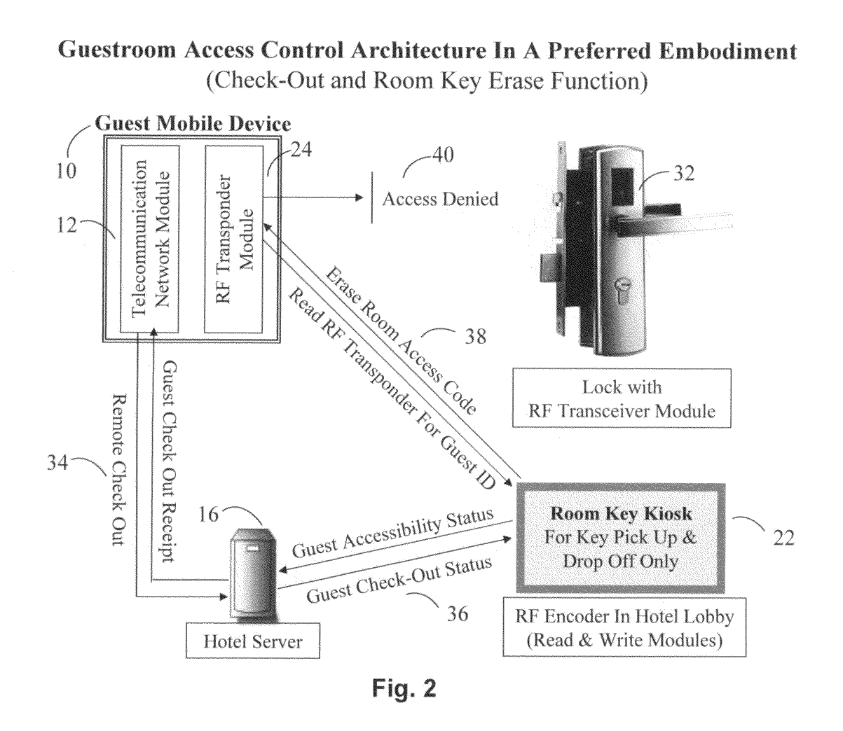

FIG. 2 represents the implementation of the present invention in checking out the guest and erasing the guestroom key from the guest's mobile device. At the time of check out after settling the payments using his mobile device, the guest can just drop off the digital key at the same encoder terminal that was used to upload the key on to the mobile device. The guest again uses his Telecommunication Network Module 12 of his mobile device 10 to connect to the hotel server 16 for requesting a check out 34. The hotel server 20 verifies the check out date and accessibility status of the guest and updates 36 the RF Encoder with guest's checked out status. At the Encoder Terminal the Read Module of the Encoder again reads the guest's mobile device RF Transponder and verifies the check out date and status of the guest with the hotel server. If check out and payment status is verified the Write Module of the RF Encoder erases the digital key code from the guest's RF Transponder memory 38 and updates the hotel database. The guest mobile device no more operates 40 the lock, and access to the room is henceforth denied. The guest check-out is completed and the room becomes available for preparation and allocation to the new guest. Thus guest accomplishes a complete hassle free fully self-served hotel experience.

Although the above preferred implementations refer to a hotel infrastructure, the principles apply equally to any other lock secured space, area or premises. For example another preferred embodiment would be residential or commercial buildings, wherein the multi-hop cellular network based access control is supplemented with the direct peer to peer radiofrequency based proximity access control. The present invention has been shown in the described embodiment for illustrative purposes only. The terms and expressions which have been employed in the foregoing specification are used as terms of description and not of limitation. As such there is no intention, in the use of such terms and expressions, of excluding equivalents of the features shown and described or portions thereof, it being recognized that the scope of the invention is defined and limited only by the claims which follow.

What I claim as my invention is:

1. A method of deploying a wireless hand held electronic device for controlling user's keyless, card-less access to a housing facility wherein the device:
a. Is a conventional telecommunication device that integrates within its structure an additional Radio Frequency (RF) transponder module;
b. Uses its subscribed wireless public telecommunication network to communicate with the facility's central computer station hosting property and customer relationship management software applications for, reservation, customer support, and rewards program, to enable user a remote self check-in, check-out, and for settling payments; but,
c. Uses direct peer to peer RF connectivity to authorize and upload (digital key pick up) a digital room access code to its device resident RF transponder after user remotely checks-in; and to terminate and erase (digital key drop off) the room access code after the user checks-out; by bringing the mobile device in close proximity of an RF encoder (reading/writing) terminal located at the entrance of the building; and such RF encoder terminal communicating with the public networks via the property's central server; either by placing or swiping the mobile device in close proximity of the said RF encoder, or just walking through, with the said handheld device, within the radiofrequency range of the RF encoder terminal; and,
d. Uses direct peer to peer RF connectivity to connect with the RF transceiver controller that operates the electronic lock, to present to the electronic lock's RF transceiver, the specific digital room access code that was encoded on the user's device resident RF transponder for user authentication, to operate the assigned room lock by bringing or just swiping the user's handheld device in sufficient proximity of the lock's RF transceiver.

2. The method of claim 1, wherein the wireless public network is a cellular phone network.

3. The method of claim 1, wherein the wireless network link is a WiFi network.

4. The method of claim 1, wherein the wireless network is a direct satellite link.

5. The method of claim 1, wherein the check-in and check-out functions are performed by the user using either the Internet or a wired phone.

6. The method of claim 1, wherein the RF transponder is built in within the wireless device hardware.

7. The method of claim 1, wherein the RF transponder chip with its antenna is glued to a secure location, either on the back cover, or in the battery compartment of the wireless device, as an add on accessory.

8. The method of claim 1, wherein the RF transponder is encoded with user's encrypted secure permanent ID, which associates the user with an authorized access privilege, a loyalty program, an affiliate membership program, or club membership program.

9. The method of claim 1, wherein the mortise of the electronic door lock is controlled by an integrated RF processor transceiver chip that reads the access code transmitted by the device resident RF transponder and signals the electronic mortise if the access code is authenticated.

10. The method of claim 1 wherein the access code encoder terminal that reads and writes the access code to the mobile device resident transponder is a kiosk for uploading the digital access code on the guest mobile device resident transponder, and erasing (key drop off) the said access code from the mobile device resident transponder when the guest checks out.

11. The method of claim 1 wherein the radiofrequency that connects the mobile device resident transponder to, either the transceiver of the access code encoder/key upload-offload kiosk or connects to the transceiver of the lock, is ultra high frequency (UHF) in the range generally between 300 MHz to 3 GHz, but preferably not less than 860 MHz and not more than 960 MHz.

12. The method of claim 1 wherein the radiofrequency that connects the mobile device resident transponder to, either the transceiver of the access code encoder/key upload-offload kiosk or connects to the transceiver of the lock, is high frequency in the range generally between 3 MHz to 30 MHz, but preferably a working frequency of 13.56 MHz.

13. The method of claim 1 wherein the read/write distance of the mobile device from the RF encoder terminal is not less than 1 cm and not more than 10 ft.

14. The method of claim 1 wherein the read distance of the mobile phone from the door lock is not less than 1 cm and not more than 10 ft.

15. The method of claim 1 wherein the digital key to operate the reserved room lock is issued by the RF encoder terminal (digital key pick up/drop off kiosk) only after the user has checked in and has been assigned a room using his hand held communication device, and terminates the digital key after the user has checked out using the same device.

16. The method of claim 1 wherein there are more than one RF encoder (reader/writer) terminals (digital key pick up/drop off kiosks) located at different locations within the housing facility, which are linked together in a local area network for user's convenient digital key upload and drop off.

17. The method of claim 1 wherein the lock-secured premise is a room or a suite in a hotel or a condominium.

18. The method of claim 1 wherein the lock-secured space is a residential or a commercial facility.

19. The method of claim 1 wherein the wireless access control system has a manual override function under the control of the facility administrator.
